(19) United States
(12) Patent Application Publication
(10) Pub. No.: US 2009/0242225 A1
(43) Pub. Date: Oct. 1, 2009

(54) PNEUMATIC TOOL WITH NOISE REDUCTION FUNCTION

(75) Inventor: Hsin-Chi Chen, Taiping City (TW)

Correspondence Address: PAI PATENT & TRADEMARK LAW FIRM, 1001 FOURTH AVENUE, SUITE 3200, SEATTLE, WA, 98154, US

(73) Assignee: TRANMAX MACHINERY CO., LTD., Taiping City (TW)

(21) Appl. No.: 12/141,080

(22) Filed: Jun. 18, 2008

(30) Foreign Application Priority Data
Mar. 28, 2008 (TW) 97111597

(51) Int. Cl. B23B 45/04

(52) U.S. Cl. 173/168

(57) ABSTRACT

A pneumatic tool capable of reducing noise includes a housing having an air intake passage and an exhaust passage, a pneumatic unit mounted in the housing, and an air-guiding member detachably mounted in the exhaust passage. The air-guiding member has an end plate with at least one hole and a lateral wall mounted on a periphery of the end plate to define an air-guiding chamber therebetween and extending divergently from the end plate and provided with at least one hole. Thus, when compressed air goes through the pneumatic tool from the air intake passage to the exhaust passage, it goes into the air-guiding chamber through the holes of the end plate and the lateral wall, and then goes out of the housing.

### BACKGROUND OF THE INVENTION

1. Field of the Invention

The present invention relates generally to a pneumatic tool, and more specifically to a pneumatic tool which has a function of reducing noise.

2. Description of the Related Art

A conventional pneumatic tool uses compressed air as its power source to drive a pneumatic unit such that the pneumatic tool doesn't cause pollution during operation and can be commonly used in many different operating environments.

When a user lets the compressed air enter the pneumatic tool, the air pressure and the airflow of supplied compressed air forces the pneumatic unit to rotate, thereby producing a torque or impact force. Thereafter, the compressed air goes out of the pneumatic tool through an air passage. However, an excessive noise is constantly generated when the compressed air flows inside the pneumatic tool such that the user will be discomforted by the excessive noise, and even worse the user's hearing may be damaged after long-term use of the pneumatic tool.

U.S. Pat. No. 6,751,952, 2004/0177980, and 2005/0039934 respectively disclose a pneumatic tool comprising a fiber body mounted in an air passage thereof for reducing noise. However, when the compressed air goes through the fiber body, grindings and oil sludge carried by the compressed air may adhere to the fiber body, lowering the working efficiency of the pneumatic tool in long-term use. As a result, the user needs to replace the fiber body, resulting in inconvenience of use and increase of cost. Further, the fiber body increases the flow resistance of the compressed air to reduce the air-guiding efficiency of the pneumatic tool and power output efficiency of the pneumatic unit. Therefore, it is desirable to provide a pneumatic tool that doesn't have the aforesaid drawbacks.

### SUMMARY OF THE INVENTION

The present invention has been accomplished in view of the above-noted circumstances. It is one objective of the present invention to provide a pneumatic tool which can effectively reduce noise and has reusable components to reduce user cost.

It is another objective of the present invention to provide a pneumatic tool, which provides better air-guiding efficiency.

To achieve these objectives of the present invention, the pneumatic tool comprises a housing having an air intake passage and an exhaust passage, a pneumatic unit mounted in the housing, and an air-guiding member detachably mounted in the exhaust passage and having an end plate with at least one hole and a lateral wall mounted on a periphery of the end plate to define an air-guiding chamber therebetween and extending divergently from the end plate and provided with at least one hole.

When compressed air goes through the pneumatic unit from the air intake passage to the exhaust passage, it will enter into the air-guiding chamber through the holes of the end plate and the lateral wall and then go out of the housing. Accordingly, the pneumatic tool of the present invention has the advantages of reducing noise, reusable components, and higher air-guiding efficiency.

The scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by way of illustration only and thus are not limitative of the present invention, and wherein:

FIG. 1 is a partial cutaway view of a pneumatic tool according to a preferred embodiment of the present invention;

FIG. 2 is a front view of the air-guiding member of the pneumatic tool according to the preferred embodiment of the present invention;

FIG. 3 is a lateral view of the air-guiding member of the pneumatic tool according to the preferred embodiment of the present invention;

FIG. 4 is a partial exploded view of the pneumatic tool according to the preferred embodiment of the present invention, and

FIG. 5 is an exploded view of the air-guiding member according to the preferred embodiment of the present invention

### DETAILED DESCRIPTION OF THE INVENTION

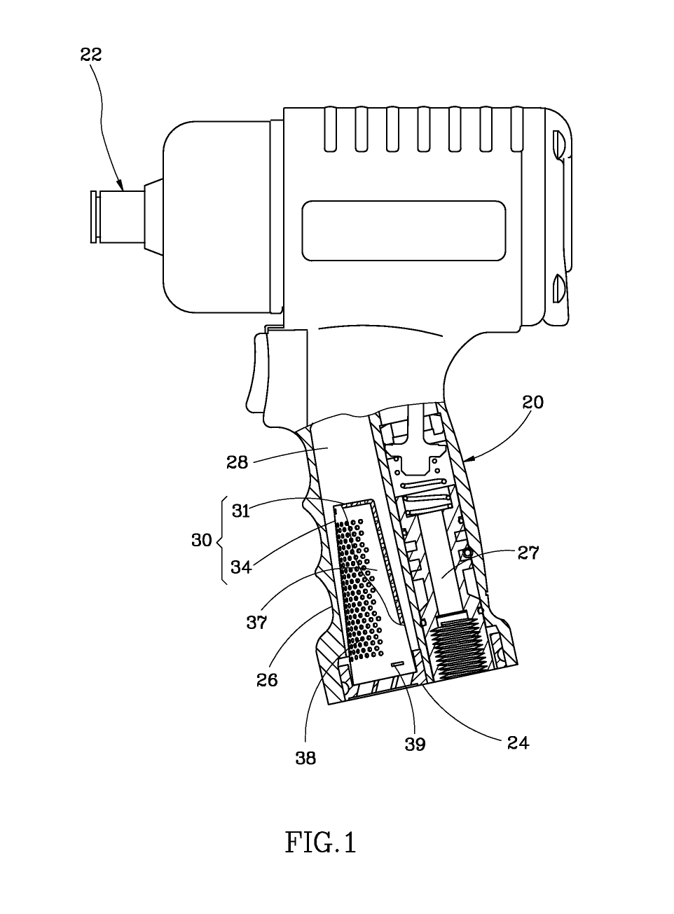

As shown in FIG. 1, a pneumatic tool in accordance with a preferred embodiment of the present invention comprises a housing 20, a pneumatic unit 22, an air-guiding member 30, and a bottom cover 24.

The housing 20 has an air intake passage 27 and an exhaust passage 28 inside a handle 26 thereof. The bottom cover 24 is mounted on a bottom end of the handle 26 to seal the air intake passage 27 and the exhaust passage 28. The pneumatic unit 22 is mounted in the housing 20 such that compressed air can enter the housing 20 through the air intake passage 27 to rotate the pneumatic unit 22, and then go out of the housing 20 through the exhaust passage 28.

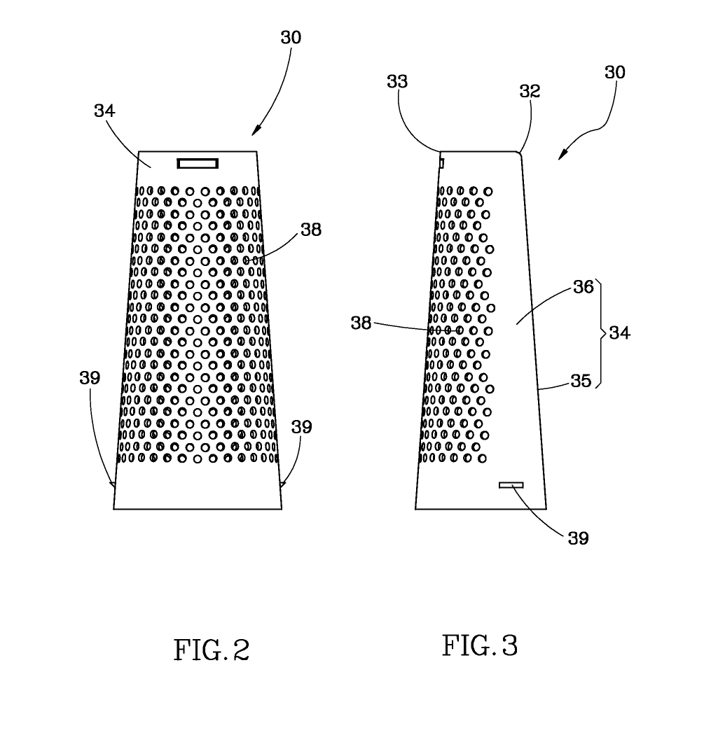

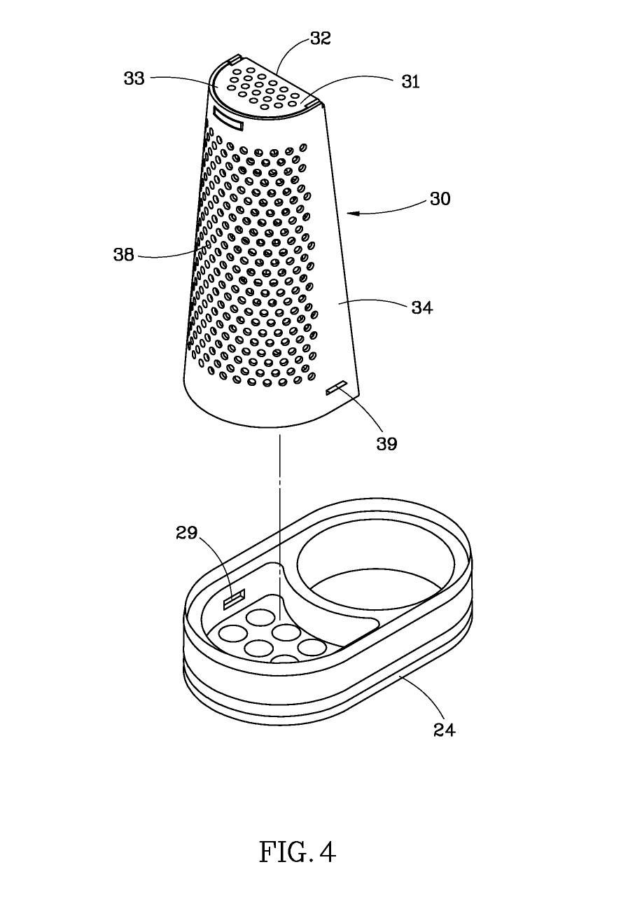

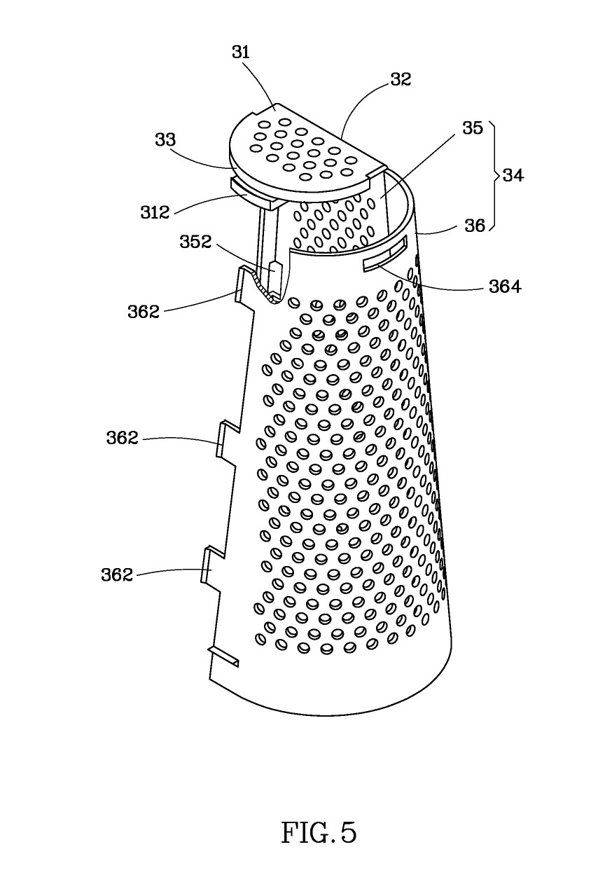

As shown in FIGS. 2 to 5, the air-guiding member 30 includes an end plate 31 and a lateral wall 34. The end plate 31 has a straight first side 32, a curved second side 33, and a hook 312 protruding from the second side 33. The lateral wall 34 has a straight connection portion 35 with a top side integrally mounted on the first side 32, a bottom side thereof extending aslope, and a curved extending portion 36. The extending portion 36 has a right side extending from a right side of the connection portion 35, a left side with three hooks 362 respectively engaged with grooves 352 of a left side of the connection portion 35, a top side with a groove 364 for insertion of the hook 312 of the end plate 31 such that the extending portion 36 is detachably connected with the end plate 31, and a bottom side extending aslope such that the lateral wall 34 extends divergently from the end plate 31 and defines an air-guiding chamber 37 with the end plate 31. Further, the end plate 31 and the lateral wall 34 each have a plurality of holes 38, and the lateral wall 34 has two hooks 39 on an outer periphery of a bottom thereof to respectively engage with two positioning portions 29 of the bottom cover 24 such that the air-guiding member 30 is detachably mounted on the end of the exhaust passage 28.

According to the aforesaid design, when the compressed air goes through the pneumatic unit 22 to rotate it from the air intake passage 27 into the exhaust passage 28, it impacts the end plate 31 first, and then flows along the inclined outer periphery of the lateral wall 34, and then goes through the holes 38 from the exhaust passage 28 into the air-guiding chamber 37, and then goes out of the bottom cover 24.

Because the end plate 31 and the lateral wall 34 of the air-guiding member 30 both have holes 38, the compressed air is allowed to go out of the housing 20 through the holes 38 such that the pneumatic tool of the present invention can effectively reduce noise generated by the flow of the compressed air by means of the air-guiding member 30. Furthermore, the lateral wall 34 has a cross-section area gradually increasing from the end plate 31, and therefore the compressed air can flow smoothly in the exhaust passage 28, thereby providing the pneumatic tool with better air-guiding efficiency. Besides, since the air-guiding member 30 is detachably mounted on the bottom cover 24 by the hooks 39, the air-guiding member 30 and the bottom cover 24 can be easily disassembled from the housing 20 to clean the grindings and the oil sludge accumulated in the holes 38 without having to replace the air-guiding member 30 for a new one, thereby lowering the user cost.

The air-guiding member of the present invention can be made with various kinds of design for the present invention. In other words, the shape of the air-guiding member is not limited to the above-mentioned embodiments. For example, the air-guiding member may have a conoid shape, an oblique conical shape or a square tapered shape as long as the air-guiding member has an inclined outer periphery.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An air-guiding member for a pneumatic tool, comprising:
an end plate having at least one hole; and
a lateral wall mounted on a periphery of said end plate to define an air-guiding chamber therebetween and extending divergently from said end plate and provided with at least one hole.

2. The air-guiding member as claimed in claim 1, wherein said lateral wall is mounted on a straight first side and a curved second side of said end plate.

3. The air-guiding member as claimed in claim 1, wherein said end plate has a straight first side and a curved second side, and said lateral wall has a connection portion with a top side integrally mounted on said first side and an extending portion with a top side detachably mounted on said second side.

4. The air-guiding member as claimed in claim 3, wherein said ends plate has a hook protruding from said second side, and said extending portion has a groove at said top side thereof for engagement of said hook.

5. The air-guiding member as claimed in claim 3, wherein said extending portion extends from a right side of said connection portion and has at least one hook engaged with a groove of a left side of said connection portion.

6. A pneumatic tool comprising:
a housing having an exhaust passage;
a pneumatic unit mounted in said housing; and
an air-guiding member detachably mounted in said exhaust passage and having an end plate with at least one hole, and a lateral wall mounted on a periphery of said end plate to define an air-guiding chamber therebetween and extending divergently from said end plate and provided with at least one hole;
whereby when compressed air goes through said pneumatic unit into said exhaust passage, it goes through said air-guiding member into said air-guiding chamber and then goes out of said housing.

7. The pneumatic tool as claimed in claim 6, wherein said lateral wall is mounted on a straight first side and a curved second side of said end plate.

8. The pneumatic tool as claimed in claim 6, wherein said end plate has a straight first side and a curved second side, and said lateral wall has a connection portion with a top side integrally mounted on said first side and an extending portion with a top side detachably mounted on said second side.

9. The pneumatic tool as claimed in claim 8, wherein said ends plate has a hook protruding from said second side, and said extending portion has a groove at said top side thereof for engagement of said hook.

10. The pneumatic tool as claimed in claim 8, wherein said extending portion extends from a right side of said connection portion and has at least one hook engaged with a groove of a left side of said connection portion.

11. The pneumatic tool as claimed in claim 6, wherein said housing has at least one positioning portion, and said lateral wall has at least one hook engaged with said positioning portion.
